(19) United States
(12) Patent Application Publication
(10) Pub. No.: US 2024/0091726 A1
(43) Pub. Date: Mar. 21, 2024

(54) MIXING ATTACHMENT CONNECTABLE TO, AND OPERABLE BY, A RECIPROCATING SAW OR TOOL TO MIX A PAINT CAN OR OTHER CONTAINER

(71) Applicant: Nathan King, Fayette, UT (US)

(72) Inventor: Nathan King, Fayette, UT (US)

(21) Appl. No.: 18/082,878

(22) Filed: Dec. 16, 2022

Related U.S. Application Data
(60) Provisional application No. 63/290,103, filed on Dec. 16, 2021.

(51) Int. Cl. B01F 33/501; B01F 31/20

(52) U.S. Cl. CPC B01F 33/50115; B01F 31/201

(57) ABSTRACT

A mixing attachment for use with a reciprocating mechanism of a reciprocating hand tool, to quickly and efficiently mix contents of paint cans or other containers, may include a support member and one or more retention ring assemblies. The support member may be disconnectably connected to the reciprocating mechanism. The one or more retention ring assemblies may be attached to the support member. The retention ring assemblies may be mounted in a longitudinal slot on the support member and include an adjustable band and a securing mechanism for tightening the adjustable band about an outer surface of a paint can.

### CROSS-REFERENCE TO RELATED APPLICATION

This application claims the benefit of U.S. Provisional Patent Application No. 63/290,103, filed on Dec. 16, 2021, which is incorporated herein by reference in its entirety.

### FIELD OF THE INVENTION

The present invention relates generally to paint mixers, and more particularly, to a mixing attachment connectable to, and operable by, a reciprocating saw or other reciprocating tool in order to automatically and consistently mix a paint can or other container.

### BACKGROUND OF THE INVENTION

Paint is often provided in cans for storage until used. The paint contained therein is often formed from a variety of different materials or components which are mixed together to provide the desired paint color and consistency. Due to the extended time between filling the paint cans with the paint and opening the paint cans to use the paint, the different materials forming the paint can un-mix or settle out requiring the user to remix the different materials or contents to regain the desired color and consistency.

Mixing may be done by hand with a stick or by use of a powered paddle or screw which can form a vortex in the contents to mix them. In order to access the paint can contents, the user or painter is required to open the paint can, which is a time consuming and messy operation. Once the paint has been mixed, it can be used with a brush or other applicator.

Some forms of paint cans do not require the cans to be opened to use the contents contained therein. These paint cans are often provided with an internal propellant to spray the contents onto the desired surface. Unfortunately, these paint cans suffer the same issues as the above paint cans. The different materials forming the desired paint color and consistency can settle out and, perhaps more importantly, when the contents do settle out they not only un-mix from each other but from the propellant as well. These types of spray paint cans almost always require mixing immediately prior to use as the contents easily disassociate from the propellant. Attempts to use these spray paint cans prior to mixing often result in a spray of propellant containing little or no mixed or even un-mixed paint.

Thus, the spray type paint cans require mixing immediately prior to use. This is typically accomplished at the job site by grasping the paint can in the user hand and repeatedly shaking the can by hand over an extended and prescribed period of time. Since the can is being shaken by hand, the timing of each individual shake is different resulting in inconsistent shaking and thus mixing of the contents of the paint can. Furthermore, since the mixing is being performed by a human over an extended period of time, human fatigue may come into play again resulting in inconsistent shaking as well as insufficient length of time of shaking as the user or shaker becomes tired. This similarly results in insufficient or incomplete mixing of the contents of the spray paint can rendering its use unacceptable.

Accordingly, there is a need for a solution to at least one of the aforementioned problems. For instance, there is an established need for a solution which allows to consistently and efficiently mix paint in a can, and which may be easily carried out by a user at a paint job site. In another example, there is a need for a method of mixing paint in a can, where the mixing can be carried out consistently and efficiently over an extended period of time.

### SUMMARY OF THE INVENTION

The present invention is directed to a mixing attachment for use with a reciprocating mechanism to mix contents of paint cans quickly and efficiently. The mixing attachment may include a support member attachable to a reciprocating mechanism and one or more retention ring assemblies attached to the support member. The retention ring assemblies may be mounted in a longitudinal slot on the support member and may include an adjustable band and a securing mechanism for tightening the adjustable band about an outer surface of a paint can.

In a first implementation of the invention, a mixing attachment for use with a reciprocating mechanism of a reciprocating hand tool may include a support member and one or more retention ring assemblies. The support member may include an attachment structure configured to connect to a reciprocating mechanism of a reciprocating hand tool for transferring a reciprocating movement of the reciprocating mechanism to the support member. The one or more retention ring assemblies may be connectable to the support member. Each retention ring assembly of the one or more retention ring assemblies may include a respective band and a respective securing mechanism for adjusting a diameter of the respective band. The mixing attachment may be configured to adopt a working configuration in which the attachment structure of the support member is connected to the reciprocating mechanism of the reciprocating hand tool, and the band of each retention ring assembly of the one or more retention ring assemblies embraces a respective container and is adjusted against the respective container by the securing mechanism of said each retention ring assembly. Also in the working configuration, the one or more retention ring assemblies and the one or more respective containers are carried by the support member and are reciprocally movable jointly with the support member responsively to a reciprocating movement of the reciprocating mechanism of the reciprocating hand tool being transferred to the support member via the attachment structure.

In a second aspect, the support member may include an elongated, main body portion, the main body portion elongately formed along a longitudinal direction.

In another aspect, in the working configuration of the mixing attachment, the longitudinal direction of the main body portion may be the same or correspond to a reciprocating direction of said reciprocating movement of the reciprocating mechanism.

In another aspect, the main body portion may include a proximal end and a longitudinally opposite, distal end. The one or more retention ring assemblies may be connectable to the support member distally of the attachment structure.

In another aspect, the attachment structure may be located at the proximal end of the main body portion.

In yet another aspect, the support member may include a slot elongately formed through the main body portion along the longitudinal direction. The bands of the one or more retention ring assemblies may be connectable to the support member through the slot.

In another aspect, in the working configuration of the mixing attachment, the bands of the one or more retention ring assemblies abut against one or more inner walls of the support member defining the slot and may be thereby frictionally prevented from moving longitudinally relatively to the support structure.

In another aspect, the mixing attachment may further include at least one limit tab affixed to the support member. The at least one limit tab may be configured to block a relative movement between the one or more respective containers and the support member in the working configuration.

In another aspect, the at least one limit tab may be L-shaped.

In yet another aspect, the one or more retention ring assemblies may include first and second retention ring assemblies. The first and second retention ring assemblies may be configured to carry the first and second containers at opposite sides of the support member in the working configuration of the mixing attachment.

In another aspect, the bands of the first and second retention ring assemblies may be arranged at said opposite sides of the support member.

In another aspect, the one or more retention ring assemblies may include first and second retention ring assemblies, wherein, in the working configuration of the mixing attachment, the bands of the first and second retention ring assemblies may be arranged on respective planes which may be transverse to the longitudinal direction.

In another aspect, the respective band of each retention ring assembly of the one or more retention ring assemblies may be configured to adopt a loosened configuration in which said respective band has a diameter which may be greater than a diameter of said respective band in the working configuration.

In yet another aspect, the one or more retention ring assemblies may include first and second retention ring assemblies, wherein, in the loosened configuration, the bands of the first and second retention ring assemblies may be arranged on respective planes which may be transverse to the longitudinal direction.

In another aspect, the securing mechanism of each retention ring assembly may include a screw configured to displace the band of said each retention ring assembly to vary the diameter of the band of said retention ring assembly.

In another aspect, the screw may be a thumb screw.

In another aspect, the attachment structure may include a stepped contour formed in the support member.

In yet another aspect, the attachment structure may include a through hole formed through the support member.

In a second implementation of the invention, a method of mixing paint cans with a reciprocating mechanism is disclosed, the method of mixing comprising:
providing a mixing attachment, the mixing attachment comprising an attachment structure configured to connect to a reciprocating mechanism of a reciprocating hand tool for transferring a reciprocating movement of the reciprocating mechanism to the support member, the mixing attachment further comprising a first retention ring assembly and a second retention ring assembly connectable to the support member, wherein each one of the first and second retention ring assemblies comprises a respective band and a respective securing mechanism for adjusting a diameter of the respective band;
mounting the attachment structure of the support member to a reciprocating mechanism;
securing a first container within the band of the first retention ring assembly;
securing a second container within the band of the second retention ring assembly; and
activating the reciprocating mechanism to produce a reciprocating movement of the reciprocating mechanism;
jointly reciprocating the support structure, first and second retention ring assemblies, and first and second containers as a result of the reciprocating movement of the reciprocating mechanism being transferred to the support structure via the attachment structure.

These and other objects, features, and advantages of the present invention will become more readily apparent from the attached drawings and the detailed description of the preferred embodiments, which follow.

### BRIEF DESCRIPTION OF THE DRAWINGS

The preferred embodiments of the invention will hereinafter be described in conjunction with the appended drawings provided to illustrate and not to limit the invention, where like designations denote like elements, and in which:

FIG. 1 presents a top, front isometric view of a mixing attachment for use with a reciprocating saw in accordance with an exemplary illustrative embodiment of the present invention;

FIG. 2 presents a bottom, rear isometric view of the mixing attachment for use with a reciprocating saw in accordance with the exemplary illustrative embodiment of the present invention illustrated in FIG. 1;

FIG. 3 presents top, plan view of the mixing attachment for use with a reciprocating saw in accordance with the exemplary illustrative embodiment of the present invention illustrated in FIG. 1;

FIG. 4 presents a top, front isometric view of the mixing attachment for use with a reciprocating saw in accordance with the exemplary illustrative embodiment of the present invention illustrated in FIG. 1 prior to a rear or bottom end of a support member of the mixing attachment being attached to the reciprocating saw;

FIG. 5 presents a top, front isometric view of the mixing attachment for use with a reciprocating saw in accordance with the exemplary illustrative embodiment of the present invention illustrated in FIG. 1 with the rear or bottom end of the mixing attachment attached to the reciprocating saw and in a condition to receive a pair of paint cans;

FIG. 6 presents a top, front isometric view of the mixing attachment for use with a reciprocating saw in accordance with the exemplary illustrative embodiment of the present invention, similar to FIG. 5, with a pair of paint cans secured within a pair of retention ring assemblies of the disclosed mixing attachment; and

FIG. 7 is a side plan view of the reciprocating saw reciprocating the mixing attachment for use with a reciprocating saw in accordance with the exemplary illustrative embodiment of the present invention illustrated in FIG. 1 to mix paint contained in the pair of paint cans.

Like reference numerals refer to like parts throughout the several views of the drawings.

### DETAILED DESCRIPTION

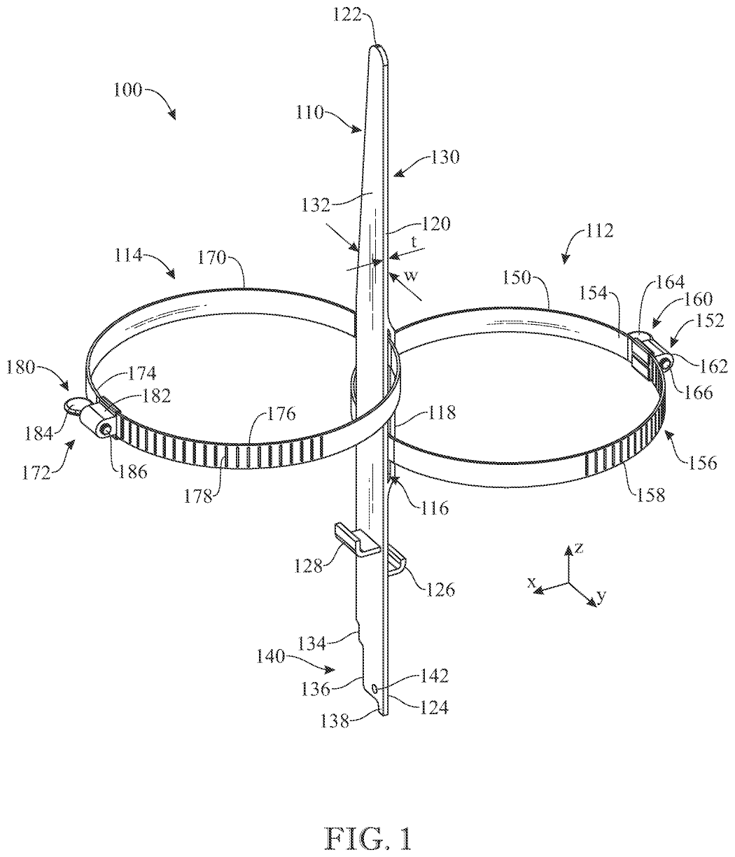

The following detailed description is merely exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure, which is defined by the claims. For purposes of description herein, the terms “upper”, “lower”, “left”, “rear”, “right”, “front”, “vertical”, “horizontal”, and derivatives thereof shall relate to the invention as oriented in FIG. 1. Furthermore, there is no intention to be bound by any expressed or implied theory presented in the preceding technical field, background, brief summary or the following detailed description. It is also to be understood that the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

Shown throughout the figures, the present invention is directed toward a mixing attachment that can be connected to a reciprocating type saw and hold one or more paint cans for mixing the contents therein as the saw reciprocates the mixing attachment.

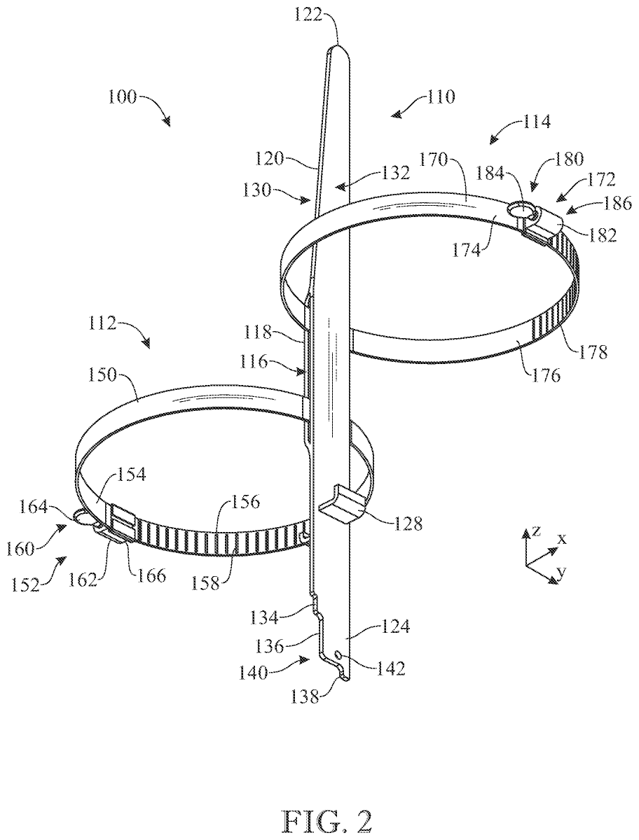

Referring to FIGS. 1-3, and initially with regards to FIGS. 1 and 2, a mixing attachment 100 for use with a reciprocating saw or tool is illustrated in accordance with an exemplary embodiment of the present invention. As shown, the mixing attachment 100 generally includes a support member 110 for attachment to a reciprocating type saw, discussed hereinbelow, and first and second retention ring assemblies 112 and 114, respectively, for securing one or more paint cans to the support member 110. It should be noted that, while the present detailed description refers generally to paint cans, the mixing attachment 100 may be used to mix the contents of alternative containers such as capped bottles, jars with lids, etc.

The support member 110 is designed to be connected to a reciprocating type saw to mix contents of paint cans retained on the support member 110 by the first and second retention ring assemblies 112 and 114, respectively, as the support member 110 is reciprocated by the reciprocating type saw. In some embodiments, such as the present embodiment, the support member 110 may be elongately formed along a longitudinal direction z, which may generally match the back-and-forth reciprocating direction of the reciprocating type saw. For instance, the support member 110, and more particularly, the main body portion 120 of the support member 110, may be formed as a generally flat body or blade, and may extend generally straight along the longitudinal direction z. The first and second retention ring assemblies 112 and 114, respectively, are initially loosely retained on the support member 110 within a longitudinally extending slot 116 formed in the support member 110. The slot 116 provides an attachment point for the first and second retention ring assemblies 112 and 114 and is defined between a support band 118 and a main body portion 120 of the support member 110. The support band 118 may be formed integrally with the main body portion 120 of the support member 110 or may be attached thereto. For example, the support band 118 and, more specifically, the slot 116, may be formed by cutting, stamping, etc. the main body portion 120 of the support member 110 to form the support band 118 and thus the slot 118. Alternatively, the slot 116 may be formed by welding, gluing or otherwise attaching the support band 118 to the main body portion 120 of the support member 110 to define the slot 116. The support member 110, including the support band 118, may be generally rigid. In some embodiments, such as the present embodiment, the slot 116 may be elongately formed along the longitudinal direction z, allowing for an adjustable mount of each one of the first and second retention ring assemblies 112 and 114 along the slot 116 and along the longitudinal direction z.

The main body portion 120 of the support member 110 includes a leading or distal end 122 and a trailing or proximal end 124. A pair of limit tabs 126 and 128 extend outwardly from first and second sides 130 and 132, respectively, of the main body portion 120 of the support member 110. The limit tabs 126 and 128 are provided to assist in supporting paint cans on the support member 110 as discussed in more detail hereinbelow. In some embodiments, as shown, the limit tabs 126 and 128 may each be generally L-shaped and oriented towards the respective first or second band 150 and 170, and thereby capable of receiving a bottom rim of a paint can. In the disclosed embodiment, the support band 118 extends from or is attached to the first side 130 of the main body portion 120 of the support member 110 as shown.

The distal end 122 of the main body portion 120 of the support member 110 in the present embodiment is rounded to prevent injury to the user, surrounding persons or property as the mixing attachment is used. However, alternative embodiments are contemplated without departing from the scope of the present disclosure. For example, the distal end 122 may be provided with an angled screwdriver flat head or pry tool termination, to assist in opening paint cans.

In order to facilitate attachment to a reciprocating type saw, the proximal end 124 of the main body portion 120 is stepped to provide an attachment point or structure 140 which conforms to the shape of an actual cutting blade (not shown) removably attachable to the reciprocating type saw. For example, in the disclosed embodiment, the attachment structure 140 at the proximal end 124 of the main body portion 120 of the support member includes a first stepped portion 134, a second stepped portion 136 and a third stepped portion 138. The first, second and third stepped portions 134, 136 and 138 are dimensioned to conform to industry standards or standards of particular brands and models of cutting blades used in reciprocating type saws. In order to secure the mixing attachment 100 to a reciprocating type saw, as discussed in more detail hereinbelow, the proximal end 124 of the main body portion 120 of the support member 110 is formed with and defines the aforementioned mount or attachment structure 140, which may include a securing hole 142 configured to be engaged by a securing structure commonly found on a reciprocating saw.

It should be noted that, in other brands or models of reciprocating saws, the attachment point may be something other than that which engages a hole. In that case, the proximal end 124 of the support member 100 is provided with a mount or attachment structure 140 consistent with that used by those particular brands and models of reciprocating mechanism. It should be further noted that while the disclosed mixing attachment is disclosed for the use with a reciprocating type hand saw, other powered hand tools provided a reciprocating motion, for example, small jack hammers, etc. may be used to reciprocate the disclosed mixing attachment 100. For simplicity, the reciprocating saw or other reciprocating tool is hereinafter referred to generally as reciprocating saw.

As noted hereinabove, the support member 110 of the mixing attachment 100 may be formed by a variety of methods. The support member 110 is preferably formed of a metallic material such as, for example, steel or steel alloys and is treated to resist breakage due to the repetitive motion of the reciprocating saw. Additionally, unlike the conventional cutting blades used with the reciprocating saw, the main body portion 120 and the support band 118 of the support member 110 are formed with sufficient thickness “t” and/or width “w” (FIG. 1), i.e. sufficient dimension along an x-y plane perpendicular to the longitudinal direction z, and chosen from a material having or treated to have sufficient strength to resist breakage while carrying the weight of the paint cans during a repeated and relatively fast reciprocating motion of the support member 110 as the contents of the paint cans are mixed by the reciprocating saw.

Referring now to FIGS. 1-3, as noted hereinabove, the first and second retention ring assemblies 112 and 114, respectively, are provided to secure one or more paint cans to the support member 110. The first retention ring assembly 112 generally includes a flexible and elongated first band 150 and a first securing mechanism 152 for tightening the first band 150 about a paint can. The first band 150 has a first end 154 secured or affixed to the first securing mechanism 152 and a free or second end 156 insertable within and movable through the first securing mechanism to tighten the first band about a paint can.

In the disclosed embodiment, the first retention ring assembly 112 is a hose clamp type assembly. The first band 150 defines a series of slots 158 adjacent the second end 156 of the first band 150. The first securing mechanism 152 includes a thumb screw 160, engageable with the series of slots 158 in the first band 150, and a housing 162 affixed or attached to the first end 154 of the first band 150. Specifically, the thumb screw 160 includes a thumb pad or tab 164 for ease in turning the thumb screw 160 and a screw shaft 166 extending through the housing 162 and rotatably mounted therein. Threads on the screw shaft 166 located within the housing 162 engage the series of slots 158 on the first band 150 such that rotation of the thumb screw 160 within the housing 162 of the first securing mechanism 152 causes a displacement of the slots 158, and thus of the first band 150, along the housing 162 and generally parallel to the screw shaft 166, thereby tightening or loosening the first securing band 150 about a paint can.

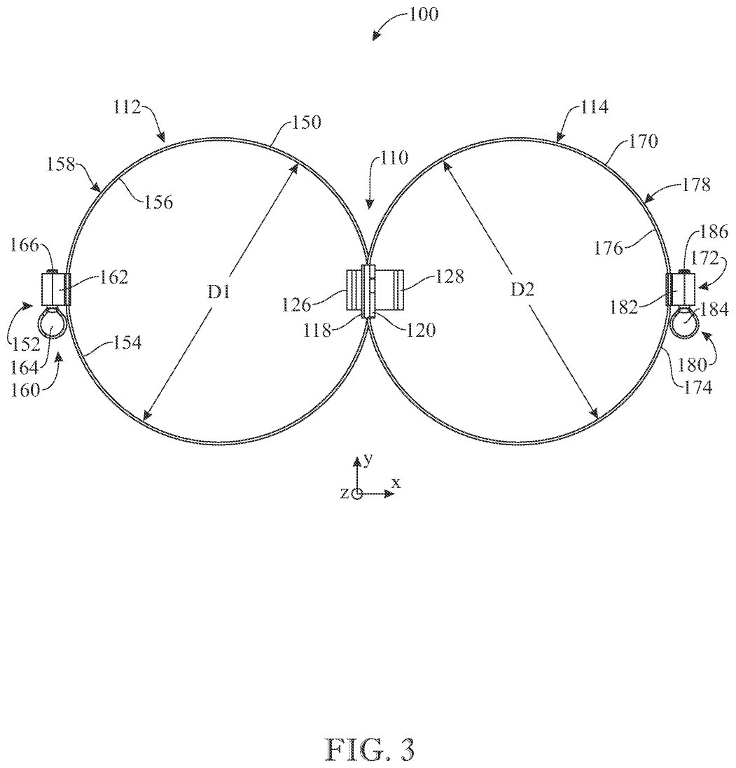

More specifically, when the thumb screw 160 is rotated in a first direction, the second end 156 of the first band 150 is drawn into and through the first securing mechanism 152 to decrease the diameter “D1” of the first securing band 150 (FIG. 3) to tighten the first securing band 150 about a paint can thereby securing a paint can within the first retention ring assembly 112 and thus to the support member 110 of the mixing attachment 110. Likewise, rotation of the thumb screw 160 in an opposite direction drives the second end 156 of the first securing band 150 back out of the first securing mechanism 152 to loosen the first securing band 150 and increase its diameter “D1” to release a paint can or allow for the insertion or release of a paint can within the first securing band 150.

The second retention ring assembly 114 is substantially identical to the first retention ring assembly 112 described hereinabove, and generally includes a second band 170 and a second securing mechanism 172. The second band 170 has a first end 174 attached to the second securing mechanism 172 and a free second end 176 insertable into and movable within the second securing mechanism 172. The second band 170 includes or defines a series of slots 178 adjacent the second end 176 of the second band 170. The second securing mechanism 172 includes a thumb screw 180 extending through a housing 182 affixed to the first end 174 of the second band 170. The thumb screw 180 includes a thumb pad or tab 184 and a screw shaft 186 extending through the housing 182 and having threads (not shown) engageable with the series of slots 178 in the second band. Rotation of the thumb screw 180 in a first direction decreases a diameter “D2” of the second band 170 (FIG. 3) and rotation of the thumb screw 180 in the opposite direction increases the diameter “D2” of the second band 170.

In some embodiments, such as the present embodiment, when tightened, the first and second bands 150 and 170 may be generally arranged in a respective r-y plane, perpendicular to the longitudinal direction z. In some embodiments, the first and second bands 150 and 170 may be sufficiently rigid such that, when loosened, the first and second bands 150 and 170 remain generally in the respective x-y plane, facilitating inserting and removing the paint can into or from within the first and second bands 150 and 170, and minimizing oscillation of a non-used one of the first and second bands 150, 170 when reciprocating the mixing attachment 100 using only the other one of the first and second bands 150, 170 to grasp (and mix) a single paint can. Alternatively or additionally, this stabilization of the first and second bands 150, 170 may be enhanced by having the first and second bands 150, 170 and support slot 116 generally flat-shaped and approximately with a same thickness, as shown, such that the first and second bands 150 and 170 are relatively snugly received within the support slot 116 (yet allowed to move transversely along the support slot 116, to enable tightening and loosening, and preferably also longitudinally, to allow to adjust the distance between each one of the first and second bands 150, 170 and the respective limit tab 126, 128).

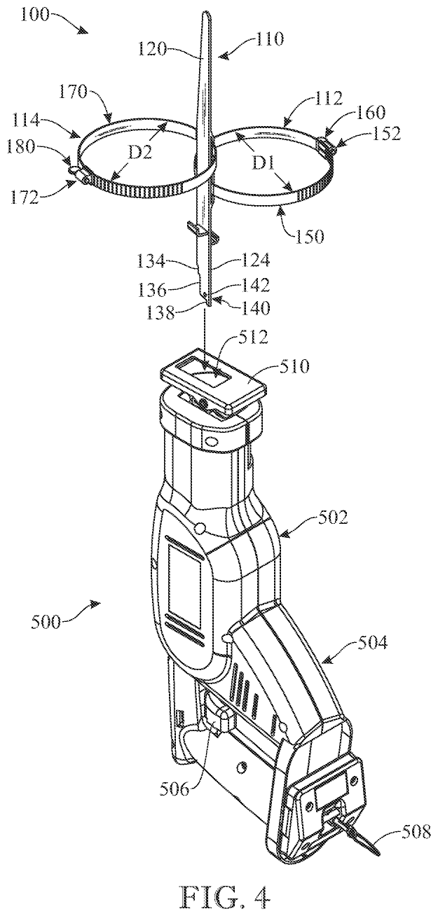

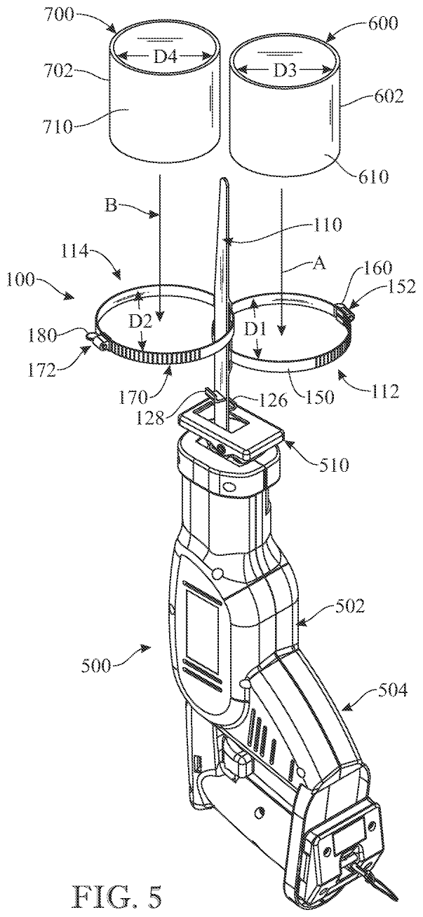

With reference now to FIGS. 4-7, and initially with regard to FIG. 4, the use of the mixing attachment 100 with a reciprocating type saw, such as, for example reciprocating saw 500, to shake contents of a first and a second paint can 600 and 700 (FIG. 5), respectively, will now be described. The reciprocating saw 500 is of the type used to rapidly and longitudinally reciprocate a cutting blade (not shown) to cut through tough materials and generally includes a body portion 502 having a handle 504 and a trigger 506. A power source 508 is provided and may include an AC or DC power cord or may utilize an on-board rechargeable battery system. The reciprocating saw 500 further includes a reciprocating mechanism 510 extending from the body portion 502 and defining an attachment slot 512 for receipt of a cutting blade or, as in the present invention, the support member 110 of the mixing attachment 100. Operation of the trigger 506 causes longitudinal movement of the reciprocating mechanism 510 and thus of the mixing attachment 100 secured thereto.

Initially, the mixing attachment 100 is prepared by loosening the thumb screws 160 and 180 of the respective first and second securing mechanisms 152 and 172 to open or increase the diameters D1 and D2 of the first and second bands 150 and 170 for subsequent receipt of the paint cans 600 and 700 (FIG. 5). The support member 110 of the mixing attachment 100 is inserted into the attachment slot 512 in the reciprocating mechanism 510 of the reciprocating saw 500 and secured therein. More specifically, the proximal end 124 of the main body portion 120 of the support member 110 is inserted into the attachment slot 512 of the reciprocating mechanism 510 such that the first, second and third stepped portions 134, 136 and 138, respectively, of the proximal end 124 are at least partially positioned within the reciprocating mechanism 510. Thereafter, a further securing device (not shown) common to reciprocating saws in general engages the securing hole 142 of the attachment structure 140 of the proximal end 124 of the support member 110 to fixedly secure the mixing attachment 100 to the reciprocating saw 500.

Turning now to FIG. 5, there are illustrated the first and second paint cans 600 and 700, respectively. In this particular illustrated application, the first and second paint cans 600 and 700 are of the aerosol powered variety which, as noted above, require the contents to be shaken for an extended period of time to ensure that the paint contents properly and fully mix with the aerosols to ensure a proper and consistent spray of paint upon use. The first paint can 600 has a cylindrical body portion 602 having an outer surface 610 and an outer diameter “D3”. Similarly, the second paint can 700 has a cylindrical body portion 702 having an outer surface 710 and an outer diameter “D4”.

The sizes of the first and second paint cans 600 and 700, respectively, can vary as well as their outer diameters D3 and D4. In order to ensure consistent mixing, and to better balance the first and second paint cans 600 and 700 on the support member 110 of the mixing attachment 100 during operation, in a preferred method of operation of the invention the sizes and diameters of the first and second paint cans 600 and 700 are substantially the same or similar.

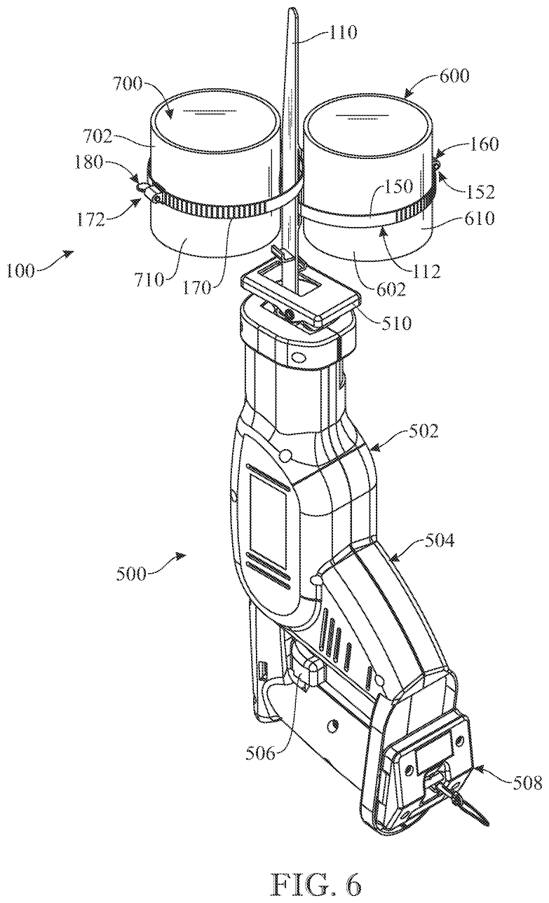

With reference to FIGS. 5 and 6, to assemble the first and second paint cans 600 and 700, respectively, to the disclosed mixing attachment 100, the first and second paint cans 600 and 700 are positioned within the first and second bands 150 and 170 of the mixing attachment 100 and secured therein. For example, the first paint can 600 is inserted in the direction of arrow “A” into the first band 150 of the first retention ring assembly 112 of the mixing attachment 100 (FIG. 5). It should be noted that, initially, the outer diameter D1 of the first band 150 is adjusted to be greater than the outer diameter D3 of the paint can 600. Thereafter, the thumb screw 160 is turned to tighten the first band 150 of the first retention ring assembly 112 about the outer surface 610 of the first paint can 600 to secure the first paint can 600 to the mixing attachment 100 (FIG. 6). It should be noted that, the thumb screw 160 is tightened sufficiently to not only secure the paint can 600 to the support member 110 but also provide sufficient tightness and thus friction of the first band 150 against the support band 118 of the support member 110 to prevent the first band 150 from sliding within the support slot 116 of the support member 110 during reciprocation operation. This aids in preventing inconsistent shaking of the first paint can 600 during operation and maximizing energy transfer from the reciprocating mechanism 510 to the contents of the paint can 600 via the mixing attachment 100.

Likewise, the second paint can 700 is inserted in the direction of arrow “B” into the second band 170 of the second retention ring assembly 114 of the mixing attachment 100 (FIG. 5) and the thumb screw 180 turned to tighten the second band 170 about the outer surface 710 of the second paint can 700 to secure the second paint can 700 to the mixing attachment 100 (FIG. 6). A sufficient tightening of the thumb screw 180 and second band 170 may cause the second band 170 to also friction against an inner wall of the support member 110 facing the support slot 116 and further facing the support band 118, thereby frictionally preventing the second band 170 from traveling along the support slot 116 during operation of the reciprocating mechanism 510. In this manner, the disclosed mixing attachment 100 is attached to the reciprocating saw 500 and the first and second paint cans 600 and 700 are secured to the mixing attachment 100 for mixing the contents contained therein.

In some applications, the first and second paint cans 600 and 700 may be longitudinally mounted such that a bottom or proximal end of each paint can is seated on the limit tab 126 and 128, respectively. The limit tabs 126 and 128 may contribute to further stabilize the paint cans longitudinally, and if L-shaped, may also stabilize the paint cans transversely, thereby contributing to maximize energy transfer and minimize damage to the reciprocating saw 500. Furthermore, the limit tabs 126 and 128 may provide a visual reference, and physical stop, of how close to the reciprocating saw 500 the paint cans may be mounted.

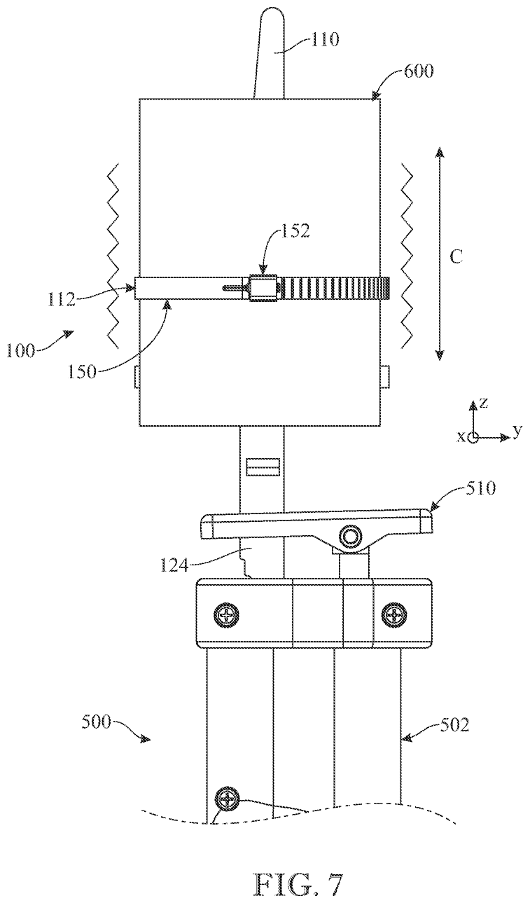

Turning now to FIGS. 6 and 7, to mix the paint and aerosol contents of the first and second paint cans 600 and 700 with the mixing attachment 100, the reciprocating saw 500 is connected to the source of power 506 (FIG. 6). The trigger 506 of the reciprocating saw 500 is then depressed or otherwise activated to initiate operation of the reciprocation mechanism 510 of the reciprocating saw 500. The reciprocating mechanism 510 rapidly and forcefully moves the mixing attachment 100, and more specifically the support member 110, back and forth along the longitudinal direction z, as indicated by arrow “C” (FIG. 7) to rapidly oscillate or shake the first and second paint cans 600 and 700.

The reciprocation mechanism 510 of the reciprocating saw 500 will typically move much faster than an individual person is capable of moving or shaking the first and second paint cans 600 and 700, respectively, by hand. This allows for a faster mixing of the contents of the first and second paint cans 600 and 700. Additionally, and perhaps more importantly, the reciprocating saw 500, through the use of the mixing attachment 100, reciprocates the first and second paint cans 600 and 700 in a very consistent manner which is not always possibly when done by hand due to inconsistent shaking of the paint cans and user hand fatigue. Thus, the disclosed mixing attachment 100, when used with a reciprocating mechanism, provides for a faster and more consistent shaking, and thus mixing, of paint cans than would be possible by hand.

In some embodiments, such as the present embodiment, the first and second bands 150 and 170 may be arranged diametrically opposite from one another with respect to the support member 110, as shown. Such a diametrical opposition may contribute to more stably reciprocate two paint cans 600, 700 contributing to maximize energy transfer from the reciprocating mechanism 510 to the paint cans 600, 700 and to minimize damage of the reciprocating saw 500.

Once the paint can contents have been successfully mixed, the paint cans 600 and 700 may be removed from the mixing attachment 100 following an inverse sequence to the paint can mounting sequence described above.

Since many modifications, variations, and changes in detail can be made to the described preferred embodiments of the invention, it is intended that all matters in the foregoing description and shown in the accompanying drawings be interpreted as illustrative and not in a limiting sense. Thus, the scope of the invention should be determined by the appended claims and their legal equivalents.

What is claimed is:

1. A mixing attachment for use with a reciprocating mechanism of a reciprocating hand tool, the mixing attachment comprising:
a support member, comprising an attachment structure configured to connect to a reciprocating mechanism of a reciprocating hand tool for transferring a reciprocating movement of the reciprocating mechanism to the support member; and
one or more retention ring assemblies connectable to the support member, wherein each retention ring assembly of the one or more retention ring assemblies comprises a respective band and a respective securing mechanism for adjusting a diameter of the respective band; wherein
the mixing attachment is configured to adopt a working configuration in which the attachment structure of the support member is connected to the reciprocating mechanism of the reciprocating hand tool, and the band of each retention ring assembly of the one or more retention ring assemblies embraces a respective container and is adjusted against the respective container by the securing mechanism of said each retention ring assembly, and further in which the one or more retention ring assemblies and the one or more respective containers are carried by the support member and are reciprocally movable jointly with the support member responsively to a reciprocating movement of the reciprocating mechanism of the reciprocating hand tool being transferred to the support member via the attachment structure.

2. The mixing attachment of claim 1, wherein the support member comprises an elongated, main body portion, the main body portion elongately formed along a longitudinal direction.

3. The mixing attachment of claim 2, wherein, in the working configuration of the mixing attachment, the longitudinal direction of the main body portion corresponds to a reciprocating direction of said reciprocating movement of the reciprocating mechanism.

4. The mixing attachment of claim 2, wherein the main body portion comprises a proximal end and a longitudinally opposite, distal end, wherein the one or more retention ring assemblies are connectable to the support member distally of the attachment structure.

5. The mixing attachment of claim 4, wherein the attachment structure is located at the proximal end of the main body portion.

6. The mixing attachment of claim 2, wherein the support member comprises a slot elongately formed through the main body portion along the longitudinal direction, wherein the bands of the one or more retention ring assemblies are connectable to the support member through the slot.

7. The mixing attachment of claim 6, wherein, in the working configuration of the mixing attachment, the bands of the one or more retention ring assemblies abut against one or more inner walls of the support member defining the slot and are thereby frictionally prevented from moving longitudinally relatively to the support structure.

8. The mixing attachment of claim 1, further comprising at least one limit tab affixed to the support member, the at least one limit tab configured to block a relative movement between the one or more respective containers and the support member in the working configuration.

9. The mixing attachment of claim 8, wherein the at least one limit tab is L-shaped.

10. The mixing attachment of claim 1, wherein the one or more retention ring assemblies comprise first and second retention ring assemblies, the first and second retention ring assemblies configured to carry the first and second containers at opposite sides of the support member in the working configuration of the mixing attachment.

11. The mixing attachment of claim 10, wherein the bands of the first and second retention ring assemblies are arranged at said opposite sides of the support member.

12. The mixing attachment of claim 1, wherein the one or more retention ring assemblies comprise first and second retention ring assemblies, wherein, in the working configuration of the mixing attachment, the bands of the first and second retention ring assemblies are arranged on respective planes which are transverse to the longitudinal direction.

13. The mixing attachment of claim 1, wherein the respective band of each retention ring assembly of the one or more retention ring assemblies is configured to adopt a loosened configuration in which said respective band has a diameter which is greater than a diameter of said respective band in the working configuration.

14. The mixing attachment of claim 13, wherein the one or more retention ring assemblies comprise first and second retention ring assemblies, wherein, in the loosened configuration, the bands of the first and second retention ring assemblies are arranged on respective planes which are transverse to the longitudinal direction.

15. The mixing attachment of claim 1, wherein the securing mechanism of each retention ring assembly comprises a screw configured to displace the band of said each retention ring assembly to vary the diameter of the band of said retention ring assembly.

16. The mixing attachment of claim 15, wherein the screw is a thumb screw.

17. The mixing attachment of claim 1, wherein the attachment structure comprises a stepped contour formed in the support member.

18. The mixing attachment of claim 1, wherein the attachment structure comprises a through hole formed through the support member.

19. A mixing attachment for use with a reciprocating mechanism of a reciprocating hand tool, the mixing attachment comprising:
a support member, comprising an elongated, main body portion, the main body portion elongately formed along a longitudinal direction and including a proximal end and a longitudinally opposite, distal end, the support member further comprising an attachment structure arranged at said proximal end and configured to connect to a reciprocating mechanism of a reciprocating hand tool for transferring a reciprocating movement of the reciprocating mechanism to the support member; and
a first retention ring assembly and a second retention ring assembly connectable to the support member distally of the attachment structure, wherein each one of the first and second retention ring assemblies comprises a respective band and a respective securing mechanism for adjusting a diameter of the respective band; wherein
the mixing attachment is configured to adopt a working configuration in which the attachment structure of the support member is connected to the reciprocating mechanism of the reciprocating hand tool, and the bands of the first and second ring assemblies embrace first and second containers, respectively, and are adjusted against the first and second containers by the respective securing mechanisms of the first and second ring assemblies, and further in which the first and second retention ring assemblies and the first and second containers are carried by the support member and are reciprocally movable jointly with the support member responsively to a reciprocating movement of the reciprocating mechanism of the reciprocating hand tool being transferred to the support member via the attachment structure, and further in which the longitudinal direction of the main body portion corresponds to a reciprocating direction of said reciprocating movement of the reciprocating mechanism.

20. A mixing attachment for use with a reciprocating mechanism of a reciprocating hand tool, the mixing attachment comprising:
a support member, comprising an elongated, main body portion, the main body portion elongately formed along a longitudinal direction and including a proximal end and a longitudinally opposite, distal end, the support member further comprising an attachment structure arranged at said proximal end and configured to connect to a reciprocating mechanism of a reciprocating hand tool for transferring a reciprocating movement of the reciprocating mechanism to the support member, the support member further comprising a slot elongately formed through the main body portion along the longitudinal direction; and
a first retention ring assembly and a second retention ring assembly connectable to the support member through the slot and distally of the attachment structure, wherein each one of the first and second retention ring assemblies comprises a respective band and a respective securing mechanism for adjusting a diameter of the respective band; wherein
the mixing attachment is configured to adopt a working configuration in which the attachment structure of the support member is connected to the reciprocating mechanism of the reciprocating hand tool, and the bands of the first and second ring assemblies embrace first and second containers, respectively, and are adjusted against the first and second containers by the respective securing mechanisms of the first and second ring assemblies, and further in which the first and second retention ring assemblies and the first and second containers are carried by the support member and are reciprocally movable jointly with the support member responsively to a reciprocating movement of the reciprocating mechanism of the reciprocating hand tool being transferred to the support member via the attachment structure, and further in which the longitudinal direction of the main body portion corresponds to a reciprocating direction of said reciprocating movement of the reciprocating mechanism.
